(19) United States
(12) Patent Application Publication
(10) Pub. No.: US 2022/0279733 A1
(43) Pub. Date: Sep. 8, 2022

(54) A MONOFILAMENT YARN SHADE NET FOR A SHADE HOUSE

(71) Applicant: GARWARE TECHNICAL FIBRES LIMITED, Pune, Maharashtra (IN)

(72) Inventors: Vayu Ramesh GARWARE, Pune (IN); Sanjay Vasudeo RAUT, Pune (IN); Ramakrishnan VIJAY, Mumbai (IN)

(21) Appl. No.: 17/632,321

(22) PCT Filed: Sep. 16, 2019
(86) PCT No.: PCT/IB2019/057775

§ 371 Date: Feb. 2, 2022

(30) Foreign Application Priority Data
Aug. 2, 2019 (IN) 201921031446

(51) Int. Cl. A01G 13/02; D04B 21/16

(52) U.S. Cl. CPC A01G 13/02; D04B 21/16; D10B 2505/18

(57) ABSTRACT

The present disclosure provides a shade net made from a monofilament yarn and a shade house with the shade net made of the monofilament yarn. The proposed yarn has a low coefficient of thermal expansion a higher stiffness. The proposed shade net has a simpler construction and is lighter. A shade net made from the proposed monofilament yarn has demonstrated a capability of maintaining temperature and humidity within the shade house with a low co-efficient of variation of 10-15%, and maintaining a reduced temperature within the shade house by up to 3° C. compared to the ambient, with a result of an increased yield of crops by about 7-10% grown within the shade net.

### TECHNICAL FIELD

The present disclosure relates generally to the field of shade nets for agriculture. In particular, the present disclosure relates to construction of a shade net for a shade house, using a monofilament yarn.

### BACKGROUND

Background description includes information that may be useful in understanding the present invention. It is not an admission that any of the information provided herein is prior art or relevant to the presently claimed invention, or that any publication specifically or implicitly referenced is prior art.

A shade house is a structure that is enclosed by woven or knotted nets inside which plants are cultivated. The shade nets allow only a required amount of sunlight through while maintaining optimum humidity and temperature inside the shade house. Shade nets are therefore, required to be sufficiently sturdy to withstand direct sunlight and other environmental degradation agents such as humidity and temperature as well.

Shade nets are commonly used in regions whose climate is hot, such as tropical regions. A typical requirement for atmosphere inside a shade house that is amenable to healthy crop growth can be a temperature in the range of 25 to 35° C. and a relative humidity in the range of 65 to 75%.

Monofilament yarns consist of a single filament. The filament size is much larger than those found in multifilament yarn. Consequently, monofilament is relatively stiff and is used mainly for the production of rope and twine. The fibre size range is typically 75-5000 denier. The monofilament yarn is preferred for making yarns used in shade nets.

Generally, for the purpose of shade nets, in order to provide additional stiffness and rigidity, two or more monofilament yarns are bundled together to make a poly yarn. Typically, two monofilament yarns are used.

However, due to intrinsic variations in properties such as coefficient of thermal expansion, uniformity of cross-section etc. between the two or more monofilament yarns, the nets can face strains due to changes in environmental factors such as temperature and humidity. This can result in changes in mesh size and distance between meshes of the shade net, due to which incident solar radiation is not dispersed uniformly through the shade net and into the shade house, causing uneven distribution of sunlight and temperature inside the shade house. Typically, poly yarns are also heavier, which adds additional stress on the shade house. Further, such variations can have a detrimental effect on the climate inside the shade house leading to a poor yield of crop.

There is, therefore, a requirement in the art for a shade net that overcomes the aforementioned limitations.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities or dimensions of items, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

### OBJECTS

A general object of the present disclosure is to provide a shade net made of a monofilament yarn that is durable and strong.

Another object of the present disclosure is to provide a shade net for a shade house that can control and maintain temperature and humidity within the shade house, with a low co-efficient of variance, namely a temperature in the range of 25 to 35° C. and a relative humidity in the range of 65 to 75%.

Another object of the present disclosure is to provide a shade net for a shade house for increased yield and quality of crops.

### SUMMARY

The present disclosure relates generally to the field of shade nets for agriculture. In particular, the present disclosure relates to construction of a shade net for a shade house, using a monofilament yarn.

In an aspect, the present disclosure provides a shade net, which includes: a monofilament yarn of a geometric configuration knitted in the form of a mesh having values of a loop length and a distance between loops in a predetermined range, wherein a plurality of meshes are coupled with one another to form a net. The values of loop length and a distance between loops of the plurality of meshes facilitates uniform dispersion of incident solar radiation through the net.

In an embodiment, each of the plurality of meshes has a loop length in the range of 2 to 4 mm.

In another embodiment, each of the plurality of meshes has a distance between loops in the range of 2 to 5 mm.

In another embodiment, the monofilament yarn has a cross-sectional shape selected from a group comprising elliptical shape and flat-elliptical shape.

In another embodiment, the monofilament yarn has a cross-sectional diameter in the range of 0.2 to 0.5 mm.

In another embodiment, the net has a thickness in the range of 0.2 to 2 mm.

In an aspect, the present disclosure provides a shade house, which includes: a shade net provided on the shade house to allow incident solar radiation to pass into the shade house. The shade net includes: a monofilament yarn of a geometric configuration knitted in the form of a mesh having values of a loop length and a distance between loops in a predetermined range, wherein a plurality of meshes are coupled with one another to form a net and. The values of loop length and a distance between loops of the plurality of meshes facilitates uniform dispersion of incident solar radiation through the net.

In an embodiment, the values of loop length and a distance between loops of the plurality of meshes facilitate maintenance of a temperature and humidity inside the shade house with a co-efficient of variation of between 10% and 15%.

In another embodiment, the shade net facilitates maintenance of a temperature inside the shade house that is below the ambient temperature by 2 to 4° C.

Various objects, features, aspects and advantages of the inventive subject matter will become more apparent from the following detailed description of preferred embodiments, along with the accompanying drawing figures in which like numerals represent like components.

### BRIEF DESCRIPTION OF DRAWINGS

The accompanying drawings are included to provide a further understanding of the present invention and are incorporated in and constitute a part of this specification. The drawings illustrate exemplary embodiments of the present invention and, together with the description, serve to explain the principles of the present invention.

FIG. 1A illustrates a morphology of a shade net made from standard two-monofilament poly yarn as known in the art.

FIGS. 1B and 1C illustrate loop microstructure and loop pattern microstructure respectively of a shade net made from standard two-monofilament poly yarn as known in the art.

FIG. 1D illustrates microstructure of a standard monofilament yarn for making a shade net as known in the art.

FIG. 2A illustrates a morphology of a shade net made from the proposed monofilament yarn, in accordance with an embodiment of the present disclosure.

FIGS. 2B and 2C illustrate loop microstructure and loop pattern microstructure respectively of a shade net made from the proposed monofilament yarn, in accordance with an embodiment of the present disclosure.

FIG. 2D illustrates microstructure of the proposed monofilament yarn, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein. Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

A shade house is a structure that is enclosed by woven or knotted nets inside which plants are cultivated. The shade nets allow only a required amount of sunlight through while maintaining optimum humidity and temperature inside the shade house. Shade nets are therefore required to be sufficiently sturdy to withstand direct sunlight and other environmental degradation agents such as humidity and temperature as well.

Shade nets are commonly used in regions whose climate is hot, such as tropical regions. A typical requirement for atmosphere inside a shade house that is amenable to healthy crop growth can be a temperature in the range of 25 to 35° C. and a relative humidity in the range of 65 to 75%.

Monofilament yarns consist of a single filament. The filament size is much larger than those found in multifilament yarn. Consequently, monofilament is relatively stiff and is used mainly for the production of rope and twine. The fibre size range is typically 75-5000 denier. The monofilament yarn is preferred for making yarns used in shade nets.

Generally, for the purpose of shade nets, in order to provide additional stiffness and rigidity, two or more monofilament yarns are bundled together to make a poly yarn. Typically, two monofilament yarns are used.

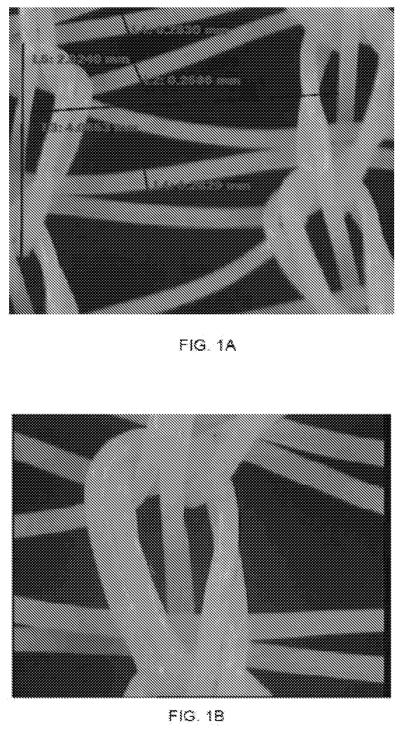

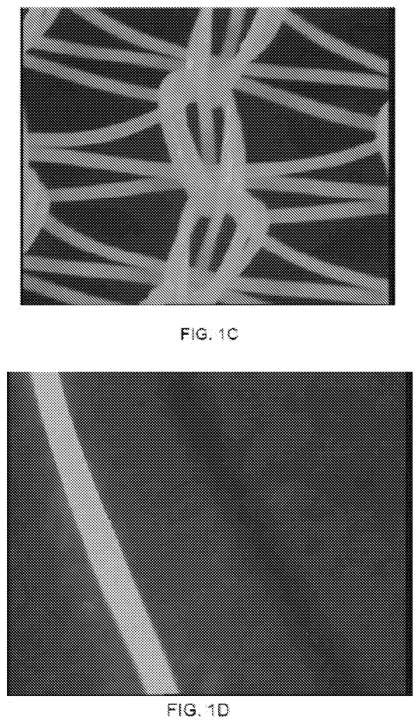

FIG. 1A illustrates a morphology of a shade net made from standard two-monofilament poly yarn as known in the art.

FIGS. 1B and 1C illustrate loop microstructure and loop pattern microstructure respectively of a shade net made from standard two-monofilament poly yarn as known in the art.

FIG. 1D illustrates microstructure of a standard monofilament yarn for making a shade net as known in the art.

For a shade factor of 50%, the shade net made from standard two-monofilament poly yarn can exhibit the following properties, as given in Table 1.

TABLE 1
Properties of shade net using
standard two-monofilament poly yarn.

| | |
|---|---|
| L5-Loop length (mm) | 2.9 |
| L1-Yarn dia (mm) | 0.28 |
| Yarn shape | Circular |
| L3-Distance between | 4.06 |
| loop (mm) | |
| Net thickness (mm) | 0.32 |
| GSM (g/m²) | 125 |

In an aspect, the present disclosure provides a monofilament yarn for making shade nets that has an elliptical or flat cross section. In another aspect, the present disclosure provides a shade net made of the monofilament yarn

In an embodiment, the shade net can be made using a process such as, but not limited to Raschel Knitting and weaving.

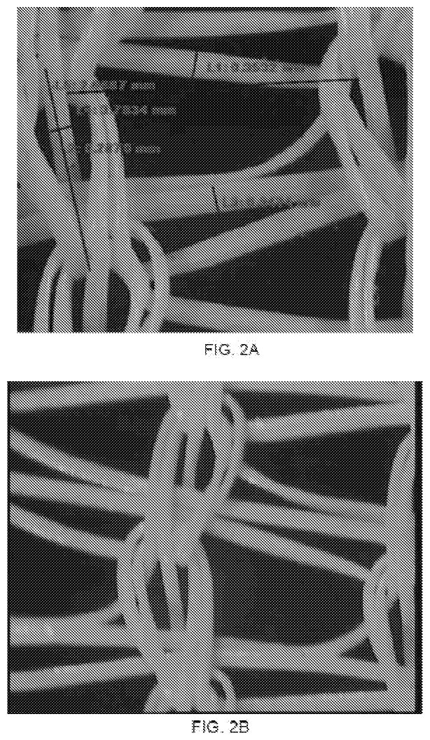

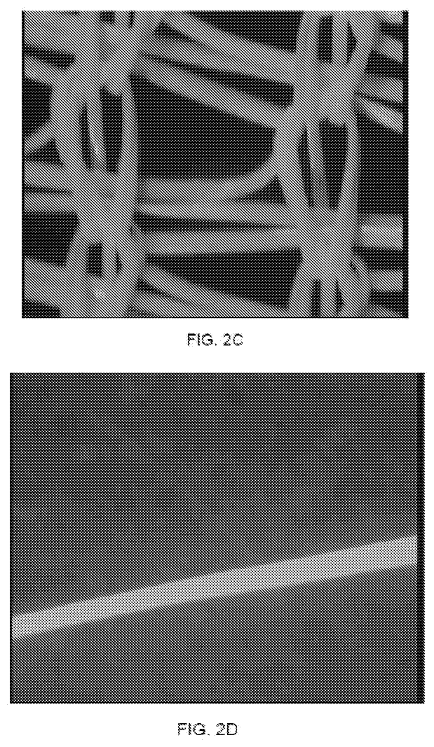

FIG. 2A illustrates a morphology of a shade net made from the proposed monofilament yarn, in accordance with an embodiment of the present disclosure.

FIGS. 2B and 2C illustrate loop microstructure and loop pattern microstructure respectively of a shade net made from the proposed monofilament yarn, in accordance with an embodiment of the present disclosure.

FIG. 2D illustrates microstructure of the proposed monofilament yarn, in accordance with an embodiment of the present disclosure.

For a shade factor of 50%, the shade net made from the proposed monofilament yarn can exhibit the following exemplary properties, as given in Table 2.

TABLE 2
Properties of shade net using the
proposed monofilament yarn.

| | |
|---|---|
| L5-Loop length (mm) | 2.6 |
| L1-Yarn dia (mm) | 0.3 |
| Yarn shape | Elliptical/ |
| | flat elliptical |
| L3-Distance between | 3.7 |
| loop (mm) | |
| Net thickness (mm) | 0.35 |
| GSM (g/m²) | 105 |

In an embodiment, as observed, the values of loop length (L5) and distance between loops (L3) for the proposed monofilament yarn is lower than for the standard two-monofilament poly yarn. The proposed monofilament yarn has a flat elliptical cross section with a diameter of about 0.3 mm. Further, the proposed monofilament yarn is lighter than the standard two-monofilament poly yarn. This implies that the shade net made from the proposed monofilament yarn has a simpler construction and is lighter. The lower values of L3 and L5 mean that the shade net can have a higher loop density which can provide greater shading.

In another embodiment, the proposed yarn has a low coefficient of thermal expansion which enables the shade net to have a longer life without significant degradation of shade factor. In another embodiment, the proposed yarn has higher stiffness due to which it can withstand deformation due to environmental factors such as wind.

In an exemplary embodiment, the yarn can be made of any suitable material such as polyolefins, polypropylene, polyester and other suitable high-density polymers. The yarn can further include suitable additives required for making of the yarn.

In an exemplary embodiment, each of the plurality of meshes has a loop length in the range of about 2 to 4 mm.

In another exemplary embodiment, each of the plurality of meshes has a distance between loops in the range of about 2 to 5 mm.

In another exemplary embodiment, the monofilament yarn has a cross-sectional shape selected from a group comprising elliptical shape and flat-elliptical shape.

In an other exemplary embodiment, the monofilament yarn has a cross-sectional diameter in the range of about 0.2 to 0.5 mm.

In another exemplary embodiment, the net has a thickness in the range of about 0.2 to 2 mm and a weight of about 60 to 600 GSM (g/m²).

In another exemplary embodiment, the denier count of the yarn can vary from about 200 to 800.

The shade house is a structure that is enclosed by woven nets inside which plants are cultivated. The shade nets allow only a required amount of sunlight through while maintaining optimum humidity and temperature inside the shade house. Shade nets are therefore required to be sufficiently sturdy to withstand direct sunlight and other environmental degradation agents such as humidity and temperature as well.

It can be appreciated that the proposed shade net can be tailored to provide a required shade factor by varying some of the parameters as listed above. In an exemplary embodiment, the shade factor of the proposed net can be varied from about 15% to a total shade, i.e., 100%.

In another embodiment, the proposed shade net, due to its uniform construction, allows for better dispersion of incident solar radiation inside the shade house. The uniform distribution of solar radiation inside the shade house facilitates uniform distribution of sunlight and temperature inside the shade house. As a result of uniform distribution of temperature inside the shade house, a regulation of humidity inside the shade house also occurs.

In another embodiment, the proposed shade net for a shade house, is capable of maintaining temperature and humidity within the shade house with a low co-efficient of variation (10-15%). Typically, shade nets made of other monofilament or tape nets show a higher coefficient of variation (more than 20%) of temperature and humidity within the shade house compared to the ambient.

In another embodiment, the shade net is capable of reducing the temperature within the shade house by 2.5-3° C. compared to the ambient. Typically, shade nets made of other monofilament nets show an increased variation (about 5° C.) between the temperature inside the shade house and the ambient.

In another embodiment, the use of a shade house with the proposed shade net provides an increased yield of crops grown within the shade house. It has been demonstrated that the use of the proposed shade net can increase overall crop yield by 7-10%. The quality of yield is also improved as evidenced by increased stem girth and lankiness of crops grown under the proposed shade net.

It should be apparent to those skilled in the art that many more modifications besides those already described are possible without departing from the inventive concepts herein. The inventive patient matter, therefore, is not to be restricted except in the spirit of the appended claims. Moreover, in interpreting both the specification and the claims, all terms should be interpreted in the broadest possible manner consistent with the context. In particular, the terms “includes” and “including” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practised with modification within the spirit and scope of the appended claims.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages

The present disclosure provides a shade net made of a monofilament yarn that is durable and strong.

The present disclosure provides a shade net for a shade house that can control and maintain temperature and humidity within the shade house, with a low co-efficient of variance, namely a temperature in the range of 25 to 35° C. and a relative humidity in the range of 65 to 75%.

The present disclosure provides a shade net for a shade house for increased yield of crops.

We claim:

1. A shade net comprising:
a monofilament yarn of a geometric configuration knitted in the form of a mesh having values of a loop length and a distance between loops in a predetermined range, wherein a plurality of meshes are coupled with one another to form a net and, wherein the values of loop length and a distance between loops of the plurality of meshes facilitates uniform dispersion of incident solar radiation through the net.

2. The shade net as claimed in claim 1, wherein each of the plurality of meshes has a loop length in the range of 2 to 4 mm.

3. The shade net as claimed in claim 1, wherein each of the plurality of meshes has a distance between loops in the range of 2 to 5 mm.

4. The shade net as claimed in claim 1, wherein the monofilament yarn has a cross-sectional shape selected from a group comprising elliptical shape and flat-elliptical shape.

5. The shade net as claimed in claim 1, wherein the monofilament yarn has a cross-sectional diameter in the range of 0.2 to 0.5 mm.

6. The shade net as claimed in claim 1, wherein the net has a thickness in the range of 0.2 to 2 mm.

7. A shade house comprising:
a shade net provided on the shade house to allow incident solar radiation to pass into the shade house, the shade net comprising:
a monofilament yarn of a geometric configuration knitted in the form of a mesh having values of a loop length and a distance between loops in a predetermined range, wherein a plurality of meshes are coupled with one another to form a net and,
wherein the values of loop length and a distance between loops of the plurality of meshes facilitates uniform dispersion of incident solar radiation through the net.

8. The shade house as claimed in claim 7, wherein the values of loop length and a distance between loops of the plurality of meshes facilitate maintenance of a temperature and humidity inside the shade house with a co-efficient of variation of between 10% and 15%.

9. The shade house as claimed in claim 7, wherein the shade net facilitates maintenance of a temperature inside the shade house that is below the ambient temperature by 2 to 4° C.

10. A shade house comprising the shade net of claim 1.
